(19) United States
(12) Patent Application Publication
(10) Pub. No.: US 2005/0161031 A1
(43) Pub. Date: Jul. 28, 2005

(54) Electronic module for internal combustion engine ignition coil

(75) Inventors: Eric Cavarero, Maisons-Laffitte (FR); Olivier Barthomeuf, Paris (FR)

Correspondence Address: FOLEY & LARDNER, 777 EAST WISCONSIN AVENUE, SUITE 3800, MILWAUKEE, WI, 53202-5308, US

(73) Assignee: Johnson Controls Automotive Electronics

(21) Appl. No.: 10/503,844

(22) PCT Filed: Feb. 6, 2003
(86) PCT No.: PCT/FR03/00378

(30) Foreign Application Priority Data
Feb. 8, 2002 (FR) 02 01576

(51) Int. Cl. F02P 3/02

(52) U.S. Cl. 123/635; 123/647

(57) ABSTRACT

The invention concerns an electronic module for internal combustion ignition coil, in particular of a motor vehicle. It comprises a case (21), at least two electronic components (25, 26) arranged in said case, means (29) for providing electrical connection between said at least two electronic components so as to constitute an electric circuit, a connection terminal (23) designed to connect said module to a high voltage output of an electrical transformer of the ignition coil, a connection terminal (24) designed to connect said module to the input of a starting plug, and means (27, 28) for electrically connecting said electronic circuit to said connection terminals.

This invention concerns an electronic module for an internal combustion engine ignition coil, an ignition coil and a manufacturing process for an ignition coil.

It is known that ignition coils are mainly composed of a transformer which is intended to provide a voltage peak, which in turn causes a spark at the electrodes of a spark plug located within a cylinder of an internal combustion engine.

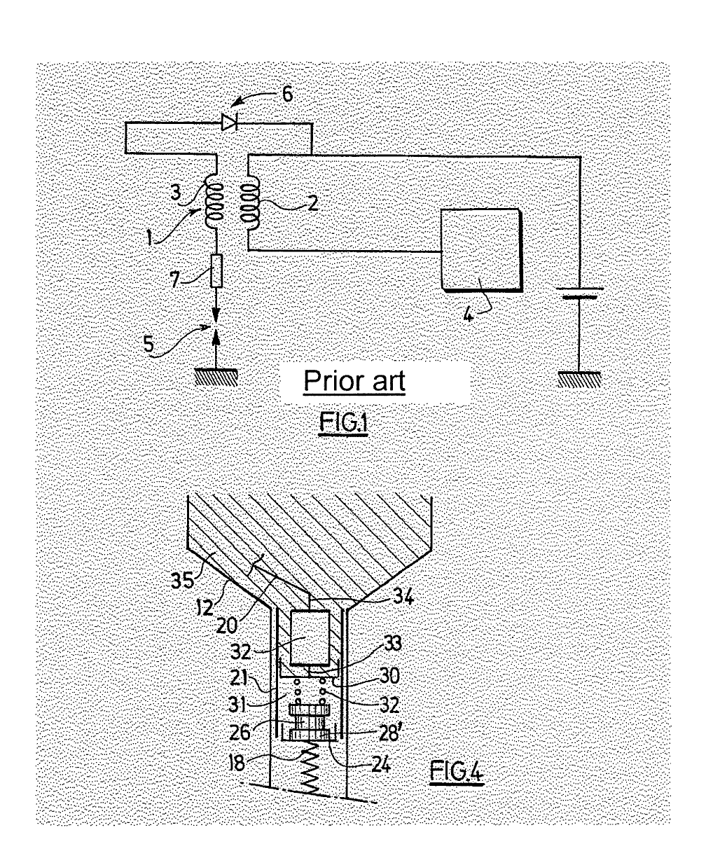

FIG. 1 illustrates schematically the prior art.

In this Figure an ignition coil 1 can be seen composed of a primary winding 2 and a secondary winding 3. The ends of the primary winding 2 are connected on one side to a vehicle battery and on the other side to an electronic control unit 4, and the terminal of the ignition coil is connected to the entry of a spark plug 5.

It is also known that a diode 6 may be used to limit the risk of having an undesired spark occur between the spark plug electrodes 5 when charging the primary winding 2. This diode 6 may be assembled as shown in the drawing between the secondary and primary windings of the ignition coil 1.

It is also known that it is possible to connect the secondary winding 3 of the ignition coil 1 to the spark plug 5 through the intermediary of a resistor 7 in series. This resistor has the effect of limiting electromagnetic interference due to the appearance of the spark.

The integration of these different elements is difficult in a reduced volume and is costly.

The goal of this invention is to level out these nuisances.

More precisely, the invention has the goal of providing an electronic module capable of integrating the different electronic components likely to be used in combination with the ignition coil transformer.

To this effect, the primary object of the invention is an electronic module for an internal combustion engine ignition coil, specifically for a motor vehicle including at least:
One case;
At least two electronic components arranged in said case;
Means to provide an electric connection in said at least two electronic components so as to form an electronic circuit;
One connection terminal suitable for connecting said module to a high voltage output terminal of an ignition coil electric transformer;
One connection terminal suitable for connecting said module to the input of a spark plug;
Means to electrically connect said electronic circuit to said connection terminals.

Hence, the different electronic components associated with the transformer part of the ignition coil are integrated in a single case possessing the necessary connection means so as to form an electronic module capable of being mounted as a block in a single operation on the ignition coil.

In one particular embodiment, said case defines a generally cylindrical interior volume open at its axial extremities, at least the first of these ends being closed by a first cap forming a connection terminal.

More particularly, said first cap may form the connection terminal suitable for connecting said module at the spark plug input.

The second axial end of said volume may be closed by a second cap forming the connection terminal suitable to connect said module to the high voltage output of the electric transformer of the ignition coil, said caps delimiting a cavity within said volume in which are arranged said electronic components.

In another embodiment, the second axial end of said volume is open, a partition being arranged in said volume at an axially intermediary location so as to close off a cavity within said volume with said first cap, a portion of said electronic components being arranged within said cavity and the other part of said electronic components being arranged in said volume outside of said cavity between its open end and said partition.

In either case, the electronic module pursuant to the invention may include elastic means in said cavity to maintain an electric connection between said at least two electronic components so as to form an electronic circuit.

These elastic means serve, furthermore, to press the different electronic components against their respective connection pieces.

More particularly, means may be planned in said cavity to connect said electronic circuit to at least one of said caps and/or said partition.

Also in a particular embodiment, at least one of said electronic components arranged in said cavity is a generally cylindrical component possessing at least at one of its ends a contact point suitable to guarantee an electric connection with one of said saps and/or said partition and/or said elastic means.

In the event that one part of the electronic components is arranged in said volume outside of said cavity between its open end and a partition, at least one of said exterior electronic components to said cavity is of a type including external connection wires, one of these wires being connected electrically to the side of said exterior partition to said cavity.

Also in this case, at least one of said exterior electronic components to said cavity may be of the type containing exterior connecting wires, one of these wires being connected electrically to a contact block suitable for connecting said module at the high voltage output terminal of the electric transformer of the ignition coils or at the input terminal of a spark plug.

At least one of the said electronic components may be an electric resistor and another electronic component may be a diode, said components being electrically connected in series.

In this case, and in a particular embodiment, the electric resistance is arranged to be connected electrically to the high voltage output terminal of the ignition coil's electric transformer and the diode is arranged to be electrically connected to the spark plug input.

A second object of the invention is an internal combustion engine ignition coil, specifically for a motor vehicle, including an electronic module as described above.

In a particular embodiment, this ignition coil comprises includes a case forming a primary housing for an electric transformer and a conduit for the means of electric connection with a spark plug input, said case forming a secondary housing for said module between said housing for the electric transformer and said conduit.

In the event that one of the ends of the case is sealed by a first cap, the ignition coil may include elastic means in said conduit in order to make an electric connection between said first cap and said spark plug input.

In the event that the second axial end of the space defined by the module case is closed by a second cap, the coil may include an insulating resin coating said electric transformer and extending in the direction of said conduit up to said second cap.

In the case, on the other hand, where the second axial end of the volume defined by the case is open and where a wall is provided in said volume at an axially intermediate location, an insulating resin may coat said electric transformer and expand in the direction of said conduit up to said partition.

In every case, the ignition coil may include elastic means for electric connection between the high voltage output of the electric transformer and said electronic module.

A third object of the invention is a manufacturing process of an ignition coil for an internal combustion engine, specifically in a motor vehicle, this process containing the steps including:
producing an electronic module as described above;
producing an electric transformer;
producing a casing forming a primary housing for said electric transformer, a conduit for the electric connection means, with a spark plug input and a second casing for said module between said housing for the electric transformer and said conduit;
arranging said electronic module in said secondary housing;
arranging said electric transformer in said primary housing;
forming an electric connection between the high voltage output of said electric transformer and said electronic module;
pouring an insulting resin in said primary housing, said resin extending from a sealing element of said module and coating said electric transformer; polymerizing said insulating resin.

We shall now describe, as a non-restrictive example, embodiments of the invention with reference to the schematic drawings in which:

FIG. 1, described above, illustrates the prior art;

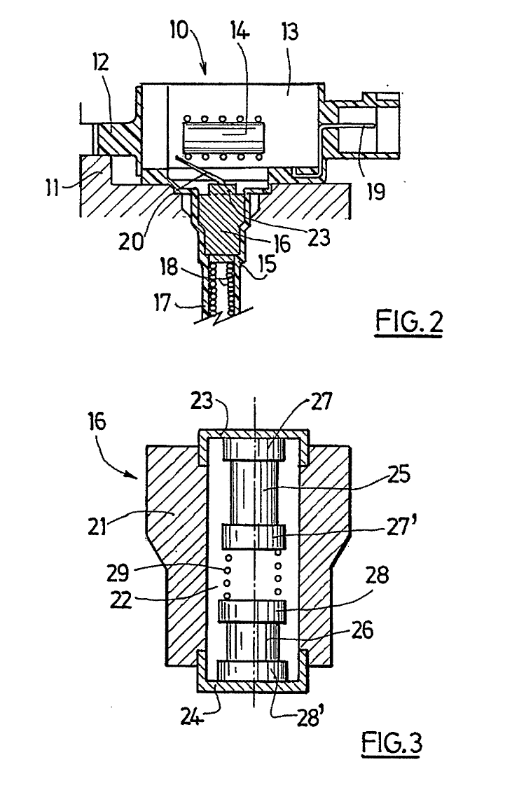

FIG. 2 is a cross-sectional view of an ignition coil according to the invention;

FIG. 3 is a cross-sectional view of an electronic module according to the invention, following the ignition coil in FIG. 2;

FIG. 4 is a partial cross-sectional view of an ignition coil according to another embodiment.

FIG. 2 shows an ignition coil 10 mounted on the head 11 of an internal combustion engine.

The ignition coil 10 contains a casing 12 manufactured from molded plastic material. The casing 12 forms a primary housing 13 for a transformer 14 and a seconding housing 15 for an electronic module 16 which shall be described hereafter in reference to FIG. 3, and a conduit 17 in which is arranged, according to known methods, a spring 18 providing the electric connection between the ignition coil 10 and a spark plug (not shown) mounted at the bottom of the indentation of the head receiving the conduit 17.

The transformer 14 is also produced, according to known methods, with, for example, a magnetic core, a concentric primary spool, a primary winding, a secondary spool, and a secondary winding¹ and a return circuit for magnetic flux. The primary winding of the transformer 14 is connected to an input connector 19 of the coil, this connector being itself connected to a non-illustrated electronic control unit.
¹ Translator's note: the way the French is written, it is unclear which coil or coils are modified by the word “concentric”, The ‘s’ at the end of the word concentriques indicates that it is plural in nature, though instead of the way I've translated above, one could just as easily speak of a core, primary spool, primary winding, concentric secondary spool, and secondary winding.

An elastic contact strip 20 is connected at one of its ends to the output of the secondary winding of the transformer 14 while its other end is supported by the input terminal of the electronic module 16 which will now be described with reference to FIG. 3.

This module 16 includes a case 21 made of molded plastic material delimiting a cylindrical interior volume 22, for example, with a circular cross-section. Each end of the volume 22 is sealed by a conductor cap 23, 24 which may be for example pressed around the edges by force or glued in order to guarantee that it stays on the module. The lateral partitions of the volume 22 and the caps 23, 24 delimit a cavity which shall receive a diode 25 and a resistor 26. Each of these components is generally cylindrical and contains two terminal contact blocks 27, 27′, respectively 28, 28′.

A spring 29 is arranged in the cavity between the components 25 and 26 so as to distance them from each other by pressing the block 27 of component 25 against the cap 23 and the block 28′ of component 26 against cap 24, all the while ensuring electric contact between blocks 27′ and 28. Hence, components 25 and 26 form an electric circuit for which the connection terminals with the outside environment are constituted by caps 23 and 24.

To produce the coil 10, one begins by independently producing the casing 12, the electric transformer 14, and the electronic module 16. The electronic module 16 is then placed in the housing 15 and the electric transformer 14 is placed in the housing 13. The contact strip 20 is then pressed against cap 23.

An insulating resin is then poured into housing 13 so as to coat the transformer 14. This resin extends up to cap 23 which also serves as a sealing unit. This resin is then polymerized.

Finally, spring 18 is placed in conduit 17.

The embodiment found in FIG. 4 mainly seeks to avoid the occurrence of an electric arc in the air contained in volume 22 between terminals 27 and 27′ of diode 25.

In this embodiment, case 21 receives only the end cap 24 intended to provide the connection with spring 18, its other end remaining open. However, an intermediate partition 30, is inserted by force or glued in the axially median area of case 21 so as to form a sealing unit. The interior walls of case 21 delimit, with cap 24 and partition 30, a cavity 31.

A resistor 26 is arranged within cavity 31. A spring 32 is arranged against resistor 26 and partition 30 to press contact block 28′ against cap 24 and provide an electric connection between the resistor and the partition 30.

A diode 32 is arranged in the case 21 between the partition 30 and the open end of this case. This diode 32 possesses two connection wires of which 33 is welded to the outside of partition 30, seen from cavity 31. The other connection wire 34 projects outside case 21.

The production of an ignition coil pursuant to the embodiment of FIG. 4 occurs generally according to the manner of the preceding example.

However, the insulating resin 35 is poured in the casing and extends up to the partition 30, thus coating the diode 32. The risks of creating an arc between the connection wires of this diode are thus limited.

With reference to FIG. 4, there has been described a case which receives only one end-cap. However, it would also be possible to design a second cap at the other end which, of course, would be partially open to allow passage of the resin.

1.- An electronic module for an internal combustion engine ignition coil, specifically for a motor vehicle, characterized by the fact that it comprises at least:
one case (21);
at least two electronic components (25, 26; 32) arranged in said case;
means (29; 30, 32) to provide an electric connection between said at least two electronic components so as to form an electronic circuit;
a connection terminal (23, 34) suitable to connect said module to a high voltage output of an ignition coil electric transformer (14);
a connection block (24) suitable to connect said module to the input of a spark plug; and
means (27, 28′) to electrically connect said electronic circuit to said connection terminals.

2- An electronic module according to claim 1, characterized by the fact that said case defines a generally cylindrical interior space open at its axial ends, at least one of these ends being sealed by a first cap (24) forming a connection terminal.

3- An electronic module according to claim 2 characterized by the fact that said first cap forms the connection terminal suitable for connecting said module to the input of the spark plug.

4- An electronic module according to any one of claims 2 and 3, characterized by the fact that the second axial end of said volume is sealed by a second cap (23) forming the connection terminal suitable for connecting said module to the high voltage output of the electric transformer of the ignition coil, said caps delimiting within said volume, a cavity (22) in which are arranged said electronic components.

5- an electronic module according to any one of claims 2 and 3, characterized by the fact that the second axial end of said volume is open, a partition (30) being arranged in said volume at a location which is axially intermediary, so as to delimit a cavity (31) in said volume with the first cap, a part of said electronic components being arranged in said cavity and the other part of said electronic components being arranged in said volume on the outside of said cavity between its open end and the partition end.

6- An electronic module according to any one of claims 4 and 5, characterized by the fact that it contains elastic means (29) in said cavity to ensure an electric connection between said at least two electronic components so as to form an electronic circuit.

7- An electronic module according to any one of claims 4 to 6 characterized by the fact that it include elastic means (32) in said cavity to connect said electronic circuit to at least one of said caps and/or said partition.

8- Electronic module according to any one of claims 4 to 7 characterized by the fact that at least one of said electronic components arranged in said cavity is a generally cylindrical component equipped on at least one of its ends with a contact block (27, 27′, 28, 28′) suitable for ensuring an electric connection with one of said caps and/or said partition and/or said elastic means.

9- An electronic module according to claim 5, characterized by the fact that at least one (32) of said electronic components which are outside of said cavity is of a type containing external connection wires (33, 34), one of these wires being electrically connected to the side of said partition exterior to said cavity.

10- An electronic module according to any one of claims 5 and 9, characterized by the fact that at least one of said electronic components outside of said cavity is of a variety that contains outside connection wires, one of these wires being electrically connected to a connection block suitable for connecting said module to the high voltage output of the electric transformer of the ignition coil or the input of a spark plug.

11- An electronic module according to any one of claims 1 and 10 characterized by the fact that at least one (26) of said electronic components is an electrical resistor and another electronic component (25, 32) is a diode, said components being connected electrically in series.

12- An electronic module according to claim 11, characterized by the fact that the electric resistor is equipped to be electrically connected to the high voltage output of the electric transformer of the ignition coil and the diode is equipped to be able to be electrically connected to the input of the spark plug.

13- An ignition coil for an internal combustion engine, specifically a motor vehicle, characterized by the fact that it comprises an electronic module according to any one of claims 1 to 12.

14- An ignition coil according to claim 13 comprising a case (12) forming a primary housing (13) for an electric transformer (14) and a conduit (17) for means of electric connection (18) with an input of a spark plug, characterized by the fact that said case forms a secondary housing (15) for said module between said casing for the electric transformer and said conduit.

15- An ignition coil according to claims 14 and 2, characterized by the fact that it includes elastic means (18) in said conduit to provide an electric connection between said first cap and said input of a spark plug.

16- An ignition coil according to any one of claims 13 to 15 and claim 4, characterized by the fact that it contains an insulating resin coating said electric transformer and extending in the direction of said conduit up to said second cap (23).

17- An ignition coil according to any one of claims 13 to 15 and claim 5, characterized by the fact it contains an insulating resin (35) coating said electric transformer and extending in the direction of said conduit up to said partition (30).

18- An ignition coil according to any one of claims 13 to 17, characterized by the fact it contains elastic means for electric connection (20) between the high voltage output of the electric transformer and said electronic module.

19- A procedure for the manufacture of an internal combustion engine ignition coil, specifically for a motor vehicle, characterized by the fact it contains the following steps consisting of:
producing an electronic module (16) according to any one of claims 1 to 12;
producing an electric transformer (14);
producing a case (12) forming a primary housing (13) for said electric transformer, a conduit (17) for the means of electric connection with a spark plug input, and a secondary housing (15) for said module between said housing for the electric transformer and said conduit;
arranging said electronic module in said second lodging;
arranging said electric transformer in said first lodging;
forming an electric connection (20) between the high voltage output of said electric transformer and said electronic module;
pouring an insulating resin (35) into said first lodging, said resin extending from a sealing element (23, 30) of said module and coating said electric transformer;
polymerizing said insulating resin.
